(19) United States
(12) Patent Application Publication
(10) Pub. No.: US 2015/0059445 A1
(43) Pub. Date: Mar. 5, 2015

(54) CONTAINER COVER TO CLOSE A TRANSPORTER AND/OR STORAGE CONTAINER

(71) Applicant: Siempelkamp Nukleartechnik GMBH, Krefeld (DE)

(72) Inventors: Inga Maren Tragsdorf, Aachen (DE); Stefan Kienitz, Duisburg (DE); Felix Benedict Kollmann, Aachen (DE); Oliver Peters, Tonisvorst (DE)

(21) Appl. No.: 14/469,631

(22) Filed: Aug. 27, 2014

(30) Foreign Application Priority Data
Aug. 27, 2013 (DE) 10 2013 109 280.2

(51) Int. Cl. B65D 47/32; B65D 81/26; G01M 3/04; B65D 43/22

(52) U.S. Cl. CPC B65D 47/32; B65D 43/22; B65D 81/263; G01M 3/04
USPC 73/49.2; 220/378; 220/560.03

(57) ABSTRACT

The object of the invention is a container cover (5) to close a filling opening (4) in a transport and/or storage container, in particular a temporary and/or permanent storage container for contaminated and/or activated substances, with at least two grooves (9) on the inside of the container cover (5) that are arranged at an interval to one another, with at least two gaskets (8) each arranged in a groove (9), and with a bypass device (18) to circulate (19) a gas, the bypass device (18) being connected with at least one groove (9) in such a way that an undefined gas volume (17) confined by the gasket (8) and the groove (9) can escape through the bypass device (18).

### CROSS REFERENCE TO RELATED APPLICATIONS

This application claims priority to German Application No. 10 2013 109 280.2, filed Aug. 27, 2013, which is incorporated herein by reference in its entirety.

The invention relates to a container cover to close a filling opening in a transport and/or storage container, in particular a temporary and/or permanent storage container for contaminated and/or activated substances, with at least two grooves on the inside of the container cover that are arranged at an interval to one another and at least two gaskets, each arranged in a groove. The invention also relates to a transport and/or storage container comprising a container body having a container bottom and at least one container side wall, as well as the container cover. Finally, the invention relates to a process for testing the leak-tightness of the transport and/or storage container when it is closed by the container cover.

Contaminated and/or activated substances such as, in particular, scrap or waste substances that are, for example, radioactively, chemically, and/or biologically contaminated and/or activated, must often be consigned to permanent storage, to avoid further contact of the scrap substances with the environment. To take contaminated and/or activated substances to permanent storage, temporary and/or permanent storage containers are known into which the scrap substances are filled for transport and/or storage. After filling, the temporary and/or permanent storage containers are closed with a container cover, for example by screwing the container cover down onto a container body of the temporary and/or permanent storage container using one or two rows of screws.

To ensure that the scrap substances cannot now escape from the temporary and/or permanent storage container, gaskets are provided between the container cover and the container body; these gaskets are often put into corresponding grooves on the container cover. International guidelines provide that temporary and/or permanent storage containers filled with contaminated and/or activated substances may not exceed certain leakage rates, to ensure that the contaminated and/or activated substances do not, with the passage of time, escape from the temporary and/or permanent storage container and present a danger to the environment and humans. Accordingly, temporary and/or permanent storage containers must, according to IP-2 or type B requirements, have the previously mentioned gaskets according to current guidelines; for example, a round container cover must have two elastomer O-ring gaskets.

Now, to determine the leakage rate between these two gaskets, that is, to determine the volume or mass of the unwanted escape from the transport and/or storage container during a time period, the so-called pressure rise method is used. To do this, first a defined test space located between the two gaskets is evacuated, before the actual pressure rise measurement begins. The so-called prepumping time that is needed to evacuate the defined test space, that is, a defined gas volume, is of decisive importance for determining the leakage rate.

Experiments have now shown that the embodiments known from the prior art can only achieve leakage rates below the specified leakage rates after prepumping times of greater than 60 hours. Although the prepumping times are not defined by known standards, the previously mentioned prepumping times greater than 60 hours are uneconomical to carry out the leak-tightness test required by standards on a temporary and/or permanent storage container, and moreover they delay the entire production process, and thus delivery to customers.

Accordingly, the goal of the invention is to point out a container cover that can reduce the prepumping time by means of a corresponding process and can nevertheless reliably carry out the leak-tightness test required by standards.

This is accomplished by the features of the independent claims. Advantageous embodiments of the invention are indicated in the subordinate claims.

Therefore, the goal of the invention is achieved by a container cover to close a filling opening in a transport and/or storage container, in particular a temporary and/or permanent storage container for contaminated and/or activated substances, with at least two grooves on the inside of the container cover that are arranged at an interval to one another, with at least two gaskets each arranged in a groove, and with a bypass device to circulate a gas, the gasket lies against the groove, in contact with it, such that an undefined gas volume is confined by the gasket and the groove, and the bypass device being connected with at least one groove in such a way that an undefined gas volume confined by the gasket and the groove can escape through the bypass device.

Thus, an essential point of the invention is that an undefined gas volume confined by the gasket and the groove can escape through the bypass device, in particular to determine the leakage rate of a temporary and/or permanent storage container closed with the container cover. Experiments have shown that there is, between a gasket with a circular cross section and a groove with a rectangular cross section, an undefined gas volume that has to be evacuated during the prepumping time in addition to a defined gas volume determining the test space, to allow secure and reliable determination of the leakage rate after that.

In the embodiments known from the prior art, selecting too small a prepumping time could mean that although the defined gas volume of the test space is evacuated, the undefined gas volume remaining between the gasket and the groove is not. The reason why is that when the temporary and/or permanent storage container is closed with the container cover, the clamping forces of the gasket are undefined, so that the undefined gas volume confined by the gasket and the groove can be pumped out only intermittently, not continuously. Sometimes the gasket lies against the groove, in contact with it, preventing the undefined gas volume formed in this way from being pumped out. However, the result has been that with time, that is, after the prepumping time has passed, embodiments known from the prior art have then allowed circulation between the undefined gas volume and the defined gas volume of the test space. The resulting pressure rise in the defined gas volume of the test space has then meant that when the leakage rate is determined, the entire gasket system of embodiments known from the prior art has been falsely evaluated as leaking.

The invention now presents a completely new way of preventing the previously mentioned pressure rise by introducing a bypass device that allows the undefined gas volume confined by the gasket and the groove to circulate freely, in particular toward the defined gas volume. This means that when the test space is evacuated the bypass device also allows the undefined gas volume to be evacuated, so that as a consequence the previously mentioned pressure rise no longer occurs and thus there also cannot be any error in determining the leakage rate.

To accomplish this, the bypass device for circulating the gas is preferably in the form of a tube or drill hole in the container cover. It is further preferred for the diameter of the gasket to correspond to the diameter of the groove, so that the gasket in the groove makes contact with the groove. It is further preferred for the diameter of the gasket to be greater than the corresponding diameter of the groove, for example 1%, 2%, 5%, and/or 10% greater than it, so that when the gasket is put into the groove it is held in it by a clamping force. It is especially preferred for the container cover to have exactly two gaskets, each of which is arranged in a groove, and for the bypass device to be connected with both grooves.

A preferred embodiment has a land arranged between the grooves, at least part of whose surface is set back from the inside surface of the container cover, in the direction of the grooves, the bypass device being connected with the set back surface of the land in such a way that the undefined gas volume can escape toward the set back surface of the land. When the container cover closes the container body, the land, which is set back from the inside surface, forms the test space, and thus the defined gas volume. In this embodiment, the bypass device now connects the undefined gas volume, which is delimited by the gasket and the groove, with the defined gas volume, which is delimited by the set back land, the container body, and the gaskets.

It is preferred for the land to extend between the grooves in such a way that the set back land allows gas to circulate freely between the first groove and the second groove (if there are two grooves). It is preferred for the land to be set back from the inside surface of the container cover by 0.3 mm, further preferred by 0.5 to 0.6 mm, and for it to have, in addition and/or alternatively, a flat surface that is parallel to the inside surface of the container cover. In addition, it is preferable for the land to extend all the way along the grooves, for example if the container cover is circular with grooves extending around the periphery, the land also extends around the periphery. In the context of the invention, it is preferable for the words “escape in the direction toward the surface of the land” to mean that the gas circulating through the bypass device can escape toward the defined gas volume, which is at least partly delimited by the surface of the land. Now, if the gas volume defined in this way is evacuated to allow subsequent determination of the leakage rate of the temporary and/or permanent storage container, evacuating the defined gas volume created in this way also evacuates the undefined gas volume.

In theory, the groove can have any shape. However, an especially preferred embodiment involves the groove being rectangular and the bypass device being arranged in the area of the bulge facing away from the inside surface of the container cover and/or from the corner of the groove facing away from it. This means that it is preferable for the cross section of the groove to have a rectangular and/or rounded shape, at least one corner being arranged facing away from the inside of the container cover. Thus, this embodiment provides that the bypass device is arranged in the area of this corner, in other words that the bypass device is preferably arranged in the groove as far as possible from the inside surface of the container cover, allowing circulation of the gas next to the corner. Thus, in this embodiment the bypass device is put “as deep as possible” in groove. This allows the undefined gas volume to escape completely, or as completely as possible, through the bypass device. A corner can be not only sharp, but can also be rounded.

There are also various possible embodiments of the bypass device. However, especially preferred embodiments involve the bypass device being in the form of a bypass groove and/or drill hole between the undefined gas volume and the inside surface of the container cover; a connection groove between the two grooves; and/or a bulge in the groove extending from the inside surface of the container cover into the groove; and/or an insert in the groove. In every case, the embodiments of the bypass device allow free circulation of the undefined gas volume confined by the gasket and the groove, either toward the inside surface of the container cover or between the two grooves. Even if it is unambiguously clear for the person skilled in the art, it should be mentioned here that the container cover preferably has the previously mentioned inside and an outside facing away from the inside, so that when the container cover is closed the inside of the container cover points toward the interior of the container, that is toward the filling opening, while the outside of the container cover faces away from the interior of the container.

Another preferred embodiment has the grooves running parallel to one another around the periphery of the inside of container cover, in an edge area. This means that the grooves are, for example, next to the edge of the container cover, for example, 3 or 5 cm from the actual edge of the container cover. In theory, the grooves can be put in the container cover in a processing step using a lathe or a milling machine, or, if the container cover is produced by a casting process, they can already be made in the mold.

In another preferred embodiment, the groove is in the form of a dovetail groove and/or the gasket is in the form of an elastomer O-ring gasket. This has the advantage that the O-ring gaskets cannot fall out of the dovetail grooves during assembly and/or disassembly, if the diameter of the gaskets is then selected somewhat larger than the groove diameter at its smallest place, so that when a temporary and/or permanent storage container is filled with radioactively contaminated and/or activated substances mechanics are exposed to as little radioactive radiation as possible when the cover is put on or removed.

In one especially preferred embodiment, part of the land between the grooves is removed and a preformed part is provided to be inserted into [the space left by] the removed part, the bypass device being arranged on the preformed part. If the grooves are milled in the container cover as dovetail grooves running around the periphery, it is necessary for the milling machine to go into the container cover in at least one place. To accomplish this, the previously mentioned part of the land is removed, the milling machine goes in to mill out the dovetail groove, and after machining the preformed part is inserted into the removed part, for example screwed into it. It is preferable if the preformed part also has a cross section to replace the part of the land previously removed at this place to form the dovetail groove.

This means that the preformed part, also called the “locking piece”, allows the O-ring gaskets also to be located in the area of this part or, if the grooves run around the periphery, at predefined positions along the entire periphery of the container. Another advantage of this embodiment is that to insert the bypass device only the locking piece needs to be changed; the container cover does not need to be mechanically machined. In theory, dovetail grooves running around the periphery can be incorporated in the container cover with only a single locking piece, however it is also possible for there to be multiple locking pieces, for example on every side of the container cover.

In theory, the bypass device can be arranged in any way on the preformed part, however it is preferred, according to an especially preferred embodiment, for the bypass device to be arranged on a face of the preformed part and to be designed as two bypass grooves each extending from a common point on the top of the preformed part down toward the bottom of the preformed part and, if the preformed part is inserted into [the space left by] the removed part, into the two grooves. It is further preferred for each face of the preformed part to have one bypass device on it; in the previously mentioned embodiment, the bypass devices run through two bypass grooves, which run along the face at a 90° angle to one another, for example, depending on the dimensioning of the preformed part. It is further preferred for the bypass grooves to end in the corners of the dovetail groove opposite the inside surface of the container cover, so that even if the O-ring gasket is maximally pressed in, the gas located between the gasket and the dovetail groove can escape from this corner. It is further preferred for the groove, for example, in its embodiment as a dovetail groove, to have two corners facing away from the inside surface of the container cover, each of which is connected with the bypass device.

The goal of the invention is further solved by a transport and/or storage container, in particular a temporary and/or permanent storage container for contaminated and/or activated substances comprising a container body having a container bottom and at least one container side wall, as well as a container cover as described above, the container body having the filling opening that can be closed by the container cover.

It is preferred to use such a transport and/or storage container to hold, store, and/or transport chemically, biologically, or radioactively contaminated and/or activated substances, and/or to consign them to permanent storage. The transport and/or storage container comprises a container body that has a container bottom and at least one container side wall. For example, the at least one container side wall can be arranged at an essentially right angle to the container bottom and/or formed as a single piece with it. In this case, it is possible for there to be only a single container side wall, if it is cylindrical and the container bottom has a circular cross section. In this embodiment, the diameter of the transport and/or storage container, which is then cylindrical, can lie in the range ≧1,000 mm to ≦1,100 mm.

However, it is preferred for the transport and/or storage container or the container body to have several container side walls, it being possible for the container bottom to have a polygonal shape when viewed from the top. In this embodiment, the container side walls are arranged at a corresponding angle to one another and can also be made as a single piece with one another and with the container bottom; it is especially preferred for them to have a rectangular shape.

To allow the contaminated and/or activated substances now to be filled into the transport and/or storage container, the container body has a filling opening. In theory, the size and shape of this opening can be freely selected, however they can be adapted to the basic shape of the container bottom, that is in particular to the shape of the container bottom when viewed from the top. To prevent the escape of contaminated and/or activated substances themselves or the escape of emissions coming from the contaminated and/or activated substances, the filling opening can be closed, in particular hermetically sealed, by the container cover. Thus, when the filling opening is closed, the transport and/or storage container is, in particular, hermetically sealed, so that contaminated and/or activated substances themselves or emissions coming from the contaminated and/or activated substances, such as, for example, radioactive radiation, cannot escape from anywhere in the transport and/or storage container.

It is preferred for the container body and/or the container cover to be made of cast iron, preferably of cast iron with spheroidal graphite, so-called spheroidal graphite iron (ductile iron). In particular, when it is made of cast iron, thus allowing use of the casting process, the transport and/or storage container can be made in an especially simple and well-defined way. In the context of this invention, cast iron can be understood to mean, in particular, an iron alloy with a high proportion of carbon, such as, for example, ≧2%, and silicon, such as, for example, 1.5%. The cast iron can contain other components, such as, for example, manganese, chromium, or nickel. The transport and/or storage container or the container body and/or the container cover can also be made or molded using casting process, in particular from so-called gray cast iron. In this form, the cast iron can also comprise carbon in the form of graphite, as in particular with spheroidal graphite.

It is further preferred for the transport and/or storage container to have, on its top and/or on its bottom, however in particular on its side facing the filling opening, a transport opening for transporting the transport and/or storage container. The transport opening can be in the form of an ISO opening, to allow the transport and/or storage container to be transported using standardized procedures. It is advantageous for the transport and/or storage container to comprise multiple transport openings, which can be arranged at the corners, for example, if the basic shape has corners. In a cuboid embodiment, for example with a square or rectangular cross section, many transport and/or storage containers can be put together and stored with a small space requirement. In this embodiment the dimensions of the transport and/or storage container can lie approximately in the range of the usual standardized ISO container. For example, the height and width can lie in the range of ≧1,200 mm to ≦2,000 mm, and the length can lie in the range of ≧1,600 mm to ≦3,000 mm.

The container cover can be fixed with the container body in various ways, screwing being preferred. To do this, the grooves or the gaskets are preferably arranged on the container cover in such a way that when the filling opening is closed by the container cover, the gaskets come to lie between the container cover and the container body, so that the transport and/or storage container is hermetically sealed. When this is done, the container cover can be screwed together with the container body using one or two rows of screws. Two rows of screws is just right to fix the container cover to the storage body in an especially secure, tight, and stable manner. The threaded joint can be implemented by thread[ed hole]s in the container body, or also by threaded studs projecting from the surface of the container body.

It is further preferred for there to be a single container cover, however it is also [possible] for there to be two container covers, the second container cover extending beyond the first container cover and overlapping it. Accordingly, two rows of threads would also be preferred, it being possible for the first cover, also called the primary cover and preferably made as described above, to be fastened by means of the first row of threads, and for the second cover to be fastened by means of the second row of threads. The second cover, the so-called secondary cover, can also have a gasket, as the primary cover does, which can also be an elastomer O-ring gasket, [or] made of microcellular rubber and/or metal. It is further preferred for the gasket of the primary cover to have an elastomer that is designed to insulate the container's interior from thermal influences and/or radioactivity, and for the outer gasket of the secondary cover to have an elastomer that is designed to insulate the container's interior from moisture. Such a design is advantageous, since a more economical material can be used for the outer gasket than for the inner gasket, so that it is possible to save the expense of a second expensive gasket for the outer gasket, the so-called sacrificial gasket.

It is also possible for the container cover to be designed in such a way that when the container cover is closed it lies at least against the container's long sides, that is, its width is essentially the same as the top of the container, that is, the transport and/or storage container or the temporary and/or permanent storage container, it being preferred for the container cover to have recesses at its corners corresponding to the transport openings. The top of the container can be wider than the container cover, so that the container forms in this way a peripheral collar, into which the container cover can be laid to close the container. Finally, it is also possible for the container cover to have a test connection, on the one hand to check the condition of the stored material and/or monitor other parameters. It is preferred for the container cover to be made of cast iron or steel.

Another embodiment provides that the container cover and the container body are arranged in such a way that the container cover fastened to the container body or the filling opening projects beyond the container body, preferably by at least 10 mm, in the direction away from the container's interior. This creates a positive contour that allows better stacking of the container. It is further preferred for the filling opening and/or the container cover to be designed as wide as possible with regard to the width of the top of the container, to allow especially simple loading of the container.

Another preferred embodiment provides that, in accordance with the previously mentioned preferred embodiment with the set-back land, the container cover closes the filling opening in such a way that there is, confined between the land and the container body, a defined gas volume that is connected by means of the bypass device with the undefined gas volume. When a leak-tightness test is carried out, this allows gas confined between the gasket and the groove, that is air, to circulate freely with the defined test volume formed by the defined gas volume, and accordingly, to be evacuated.

The goal of the invention is also solved by a process to test the leak-tightness of a transport and/or storage container closed with the container cover, as described above, with the step: a) Evacuation of the gas volume. Thus, when the gas volume is evacuated, the bypass device means that not only the defined gas volume of the test space formed by the set-back land is evacuated, but also air or gas that might possibly remain in the undefined gas volume. This allows a substantial reduction, compared with the embodiments known from the prior art, in the so-called prepumping time required for evacuation to determine the previously mentioned leakage rate using another preferred embodiment with step b) Determining the leakage rate of the transport and/or storage container. As a result, the process in combination with the inventive transport and/or storage container represents significant progress over the prior art, allowing far more exact and more reliable testing of the leak-tightness of such a transport and/or storage container, while reducing prepumping times.

The invention is explained in detail below on the basis of preferred embodiments, which make reference to the attached drawing.

The figures are as follows

### BRIEF DESCRIPTION OF THE DRAWINGS

FIG. 1 Sectional view of a preferred embodiment of a transport and/or storage container with its container cover closed;

FIG. 2 Sectional view of a detail of FIG. 1 in the area of the container cover;

FIG. 3 Another schematic view of the container cover described in the preferred embodiment;

FIG. 4 Schematic view of the forces acting on a gasket in the embodiment shown in FIG. 3;

FIG. 5-7 Top view of other embodiments of a detail of the container cover;

FIG. 8 Top view of the container cover in accordance with the preferred embodiment; and

FIG. 9 A preformed part to be inserted into the container cover shown in FIG. 8.

### DETAILED DESCRIPTION OF THE DRAWINGS

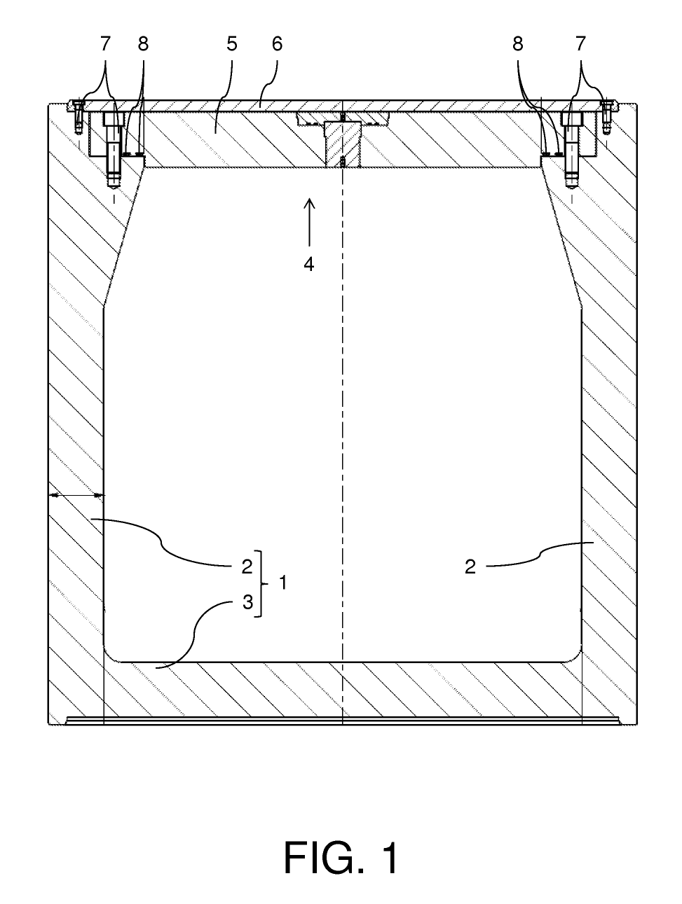

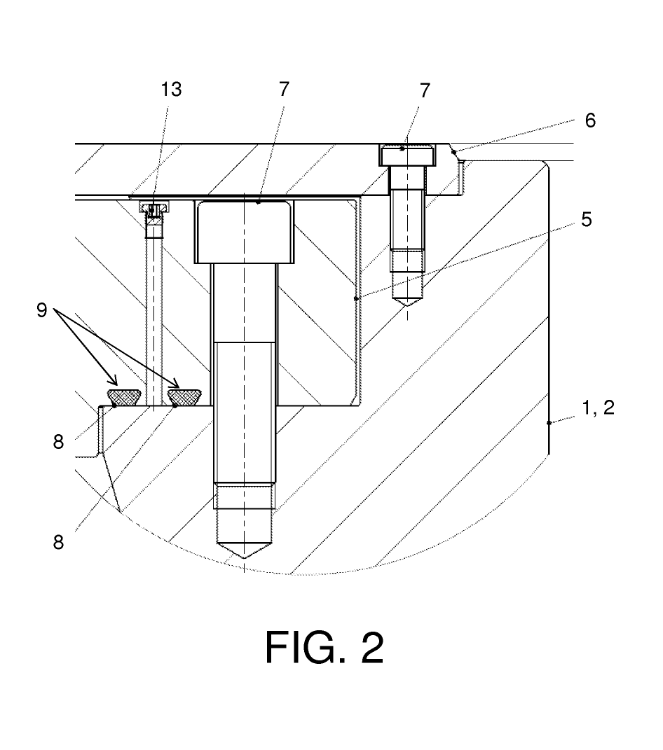

FIG. 1 shows a sectional view of a transport and/or storage container in accordance with a preferred embodiment of the invention. The transport and/or storage container, in the context of the invention also called a temporary and/or permanent storage container, a transport and storage container, or simply a container, serves to hold and store contaminated and/or activated substances, for example radioactively, chemically, and/or biologically contaminated and/or activated substances, and is made of cast iron.

Here the transport and/or storage container has a rectangular cross section, container body 1 having four container side walls 2, two of which are shown in the sectional view in FIG. 1, and a container bottom 3, and it is made as a single piece. A filling opening 4 of container body 1 is closed with a container cover 5. Container cover 5, also called the primary cover, in turn is closed with a secondary cover 6. To do this, both container cover 5 and secondary cover 6 are screwed together with container body 1 by means of screws 7.

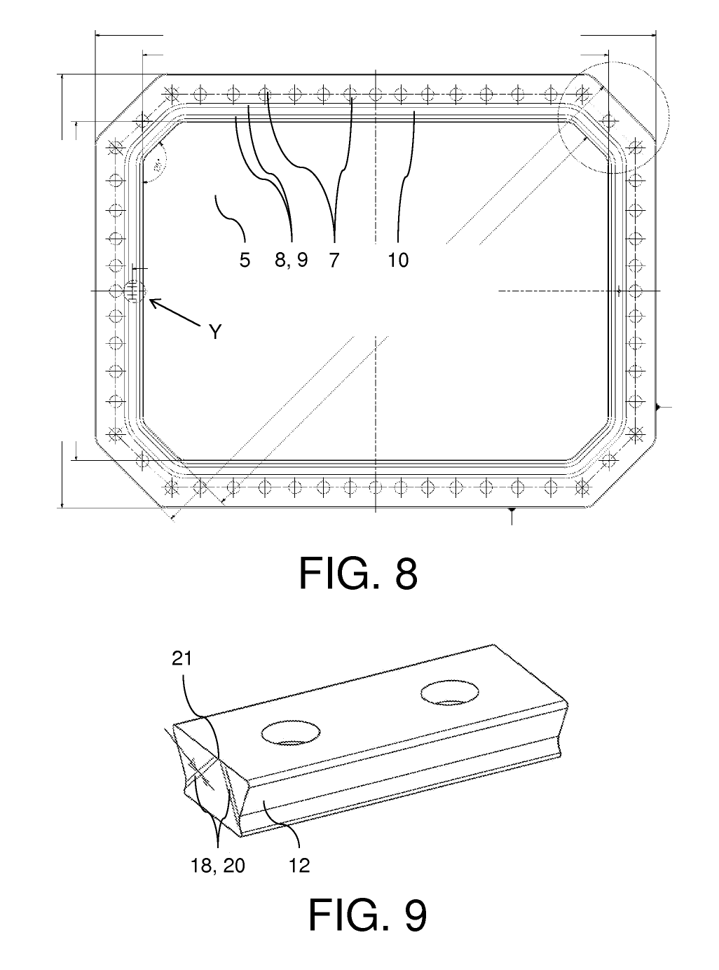

Now, to provide a hermetic seal on container body 1, container cover 5 has gaskets 8 arranged in two grooves 9 spaced at an interval from one another on the inside of container cover 5, that is, facing the container's interior. Here grooves 9 are designed as dovetail grooves and, as can be seen in the top view of the inside of container cover 5 shown in FIG. 8, they run parallel to one another around the periphery in an edge area 10 of container cover 5.

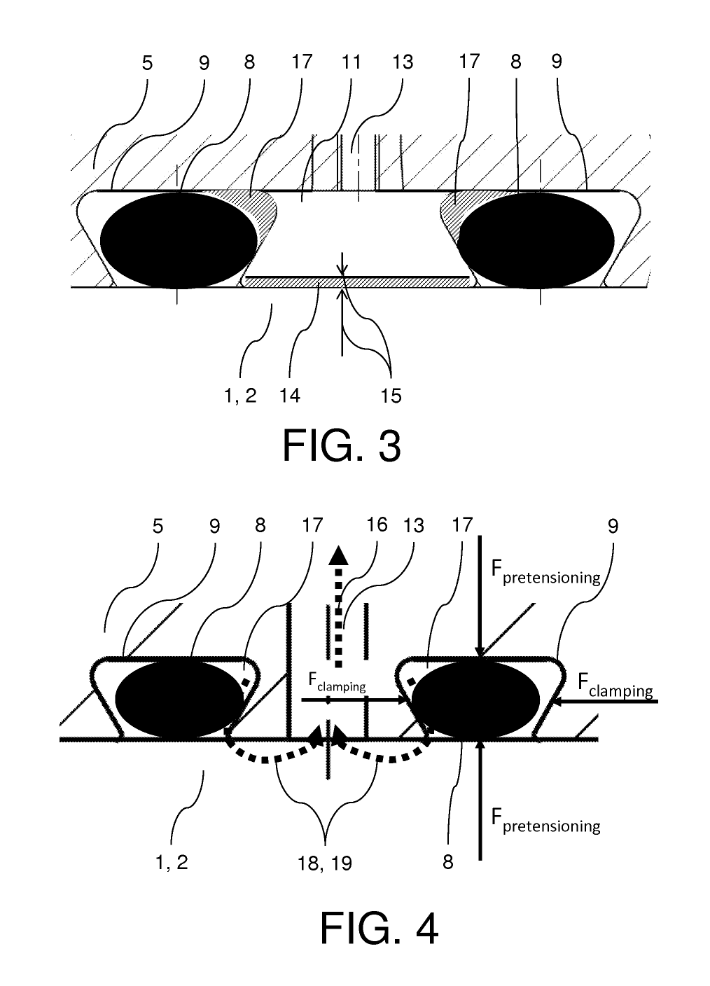

As can be seen from the other schematic sectional view in FIG. 3 of the gaskets inserted into dovetail grooves 9, the two grooves 9 have a land 11 between them. Now, in order to be able to mill the dovetail grooves 9 in container cover 5, it is necessary to remove land 11 in one place, labeled Y in FIG. 8, so that a milling head can enter container cover 5. After dovetail grooves 9 are milled, to ensure that gaskets 8 now remain in their predefined positions even at the place designated with Y in FIG. 8, a preformed part 12 shown in FIG. 9, also called the locking piece, is inserted into the place designated with Y in FIG. 8, to replace the removed part of land 11.

Corresponding international guidelines require that transport and/or storage containers for contaminated and/or activated substances do not exceed certain leakage rates. The leakage rate between the two gaskets 8, which are elastomer O-ring gaskets here, as can be seen in FIG. 3, is determined by means of the pressure rise method.

To do this, gas located between the two gaskets 8 is evacuated from a so-called test space 14, here also called defined gas volume 14, through an evacuation channel 13. To do this, the surface of land 11 is set back from the inside surface of container cover 5, symbolized in FIG. 3 by arrows 15, producing test space 14 with defined gas volume 14 between the surface of land 11 and container body 1. Here, land 11 is set back by the distance 0.5 to 0.6 mm, designated with arrows 15, with respect to the inside surface of container cover 5. The evacuation during the so-called prepumping time, shown by the other arrow 16, evacuates defined gas volume 14, which is delimited by the two O-ring gaskets 8, land 11, and container body 1.

Now if container cover 5 is connected with container body 1 by means of screws 7, as shown in FIG. 4, various forces shown in FIG. 4 act on O-ring gaskets, namely pretensioning forces, on the one hand, and clamping forces, on the other hand. The pretensioning forces, designated with F_{pretensioning}, are predetermined on the basis of the design of dovetail grooves 8, and are of decisive importance for the leak-tightness of the transport and/or storage container.

By contrast, the clamping forces, designated in FIG. 4 as F_{clamping}, are not precisely defined; the result is that during the evacuation of test space 14, an undefined gas volume 17 (shown in FIG. 3) confined by gaskets 8 and grooves 9 can be evacuated only intermittently, not continuously. The reason why is that the two O-ring gaskets 8 sometimes lie against and in contact with dovetail grooves 9, thus preventing the gas, for example air, located in undefined gas volume 17 from being pumped out.

In embodiments known from the prior art, this led to a slow, but measurable pressure equalization between defined gas volume 14 and undefined gas volume 17 during the pressure rise test. The result of this pressure rise was that the transport and/or storage container was evaluated as leaking, even if long prepumping times greater than 60 hours were selected.

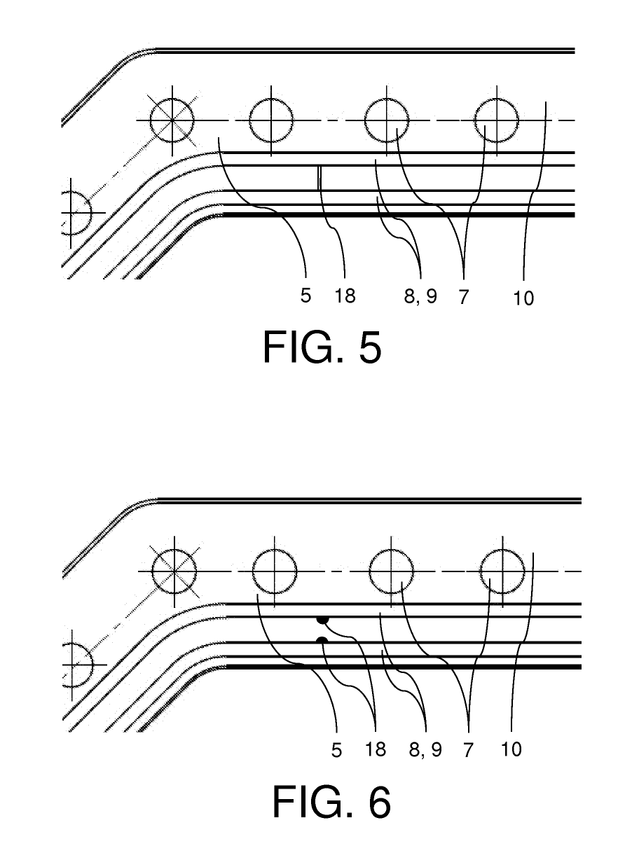

The invention now provides a bypass device 18, shown in FIG. 5 through 7, which allows gas circulation between undefined gas volume 17 and defined gas volume 14, shown by arrow 19 in FIG. 4. This means that evacuation 16 of defined gas volume 14 also evacuates undefined gas volume 17 along with it through bypass device 18.

The result is that the previously mentioned pressure rise in defined gas volume 14 is avoided, that is, the quality of the leakage rate measurements is significantly improved. Thus, in other words bypass device 18 creates a bypass so that during the prepumping phase for subsequent determination of the leakage rate, gas from undefined gas volume 17, which is delimited or confined by gasket 8 and groove 9, can also be pumped out through evacuation channel 13.

Now there are various possible embodiments of bypass device 18. In the case of a preformed part 12 shown in FIG. 9, bypass device 18 can be realized in the form of bypass grooves 20 provided on the faces of preformed part 12. To accomplish this, bypass grooves 20 each extend from a common point 21 on the surface of preformed part 12 down to the bottom of preformed part 12 and into the two grooves 9 in such a way that bypass grooves [20] end in a rounded corner of a rectangular dovetail groove 9 or “very deep” in dovetail groove 9.

Such an embodiment is advantageous, since when container cover 5 is screwed together with container body 1 the pressing of gaskets 8 means that the pressure against the flanks of dovetail grooves 8 is no more linear pressure, but rather surface pressure. In addition, a gasket 8 made of elastomer expands with rising temperatures. For this reason, it is especially advantageous for bypass device 18, for example if its cross section is smaller than that of the O-ring, to be put correspondingly “deep” on the sides of dovetail groove 9. It is further advantageous for bypass grooves 20 to be provided on the two opposite faces of preformed part 12 and have a diameter of 2.5 mm given a depth of 1.5 mm [sic].

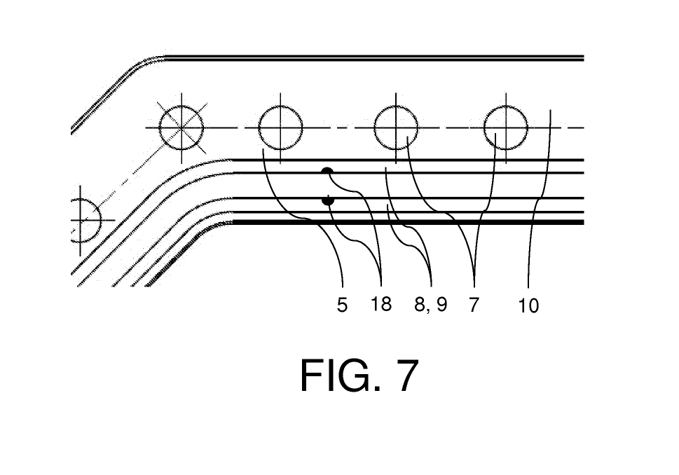

In the embodiment shown in FIG. 5, bypass device 18 can also be made by countersinking between the two dovetail grooves 9. FIG. 6 shows another embodiment in the form of local bulges in dovetail grooves 9. Another possible embodiment of bypass device 18, instead of bypass grooves 20, is to make drill holes from land 11 between the two dovetail grooves 9 into the lower area of grooves 9. Finally, FIG. 7 shows bypass device 18 in the form of inserts inserted into the grooves 9 leaving open a bypass from lower groove area 9. In addition, brackets can be used, which are built in, in contrast to the variant shown in FIG. 6.

The result is that the invention allows far more exact and more reliable determination of the leakage rate while simultaneously reducing the prepumping time.

### LIST OF REFERENCE NUMBERS

Container body 1
Container side wall 2
Container bottom 3
Filling opening 4
Container cover, primary cover 5
Secondary cover 6
Screws 7
Gasket 8
Groove, dovetail groove 9
Edge area 10
Land 11
Preformed part 12
Evacuation channel 13
Test space, defined gas volume 14
Arrow (set back arrangement) 15
Arrow (evacuation) 16
Undefined gas volume 17
Bypass device 18
Arrow (circulation) 19
Bypass groove 20
Point 21
Removed part Y cm We claim:

1. A container cover (5) to close at least one filling or cover opening (4) in a transport and/or storage container, in particular, a temporary and/or permanent storage container for contaminated and/or activated substances, with
at least two grooves (9) on the inside of the container cover (5) that are arranged at an interval to one another, at least two gaskets (8) each arranged in a groove (9), and a bypass device (18) to circulate (19) a gas,
the gasket (8) lies against the groove (9), in contact with it, such that an undefined gas volume (17) is confined by the gasket (8) and the groove (9), and
the bypass device (18) being connected with at least one groove (9) in such a way that the undefined gas volume (17) confined by the gasket (8) and the groove (9) can escape through the bypass device (18).

2. The container cover (5) of claim 1, the grooves (9) having a land (11) arranged between them, at least part of whose surface is set back (15) from the inside surface of the container cover (5), in the direction of the grooves (9), and the bypass device (18) being connected with the set back (15) surface of the land (11) in such a way that the undefined gas volume (17) can escape toward the set back (15) surface of the land (11).

3. The container cover (5) of claim 1, in which the groove (9) is rectangular and the bypass device (18) is arranged in the area of the bulge facing away from the inside surface of the container cover (5) and/or from the corner of the groove (9) facing away from it.

4. The container cover (5) of claim 1, in which the bypass device (18) is in the form of a bypass groove (20) and/or drill hole between the undefined gas volume (17) and the inside surface of the container cover (5); the bypass device (18) is in the form of a connection groove between the grooves (9); and/or the bypass device (18) is in the form of a bulge in the groove (9) extending from the inside surface of the container cover (5) into the groove (9); and/or the bypass device (18) is in the form of an insert in the groove (9).

5. The container cover (5) of claim 1, in which the grooves (9) run parallel to one another around the periphery of the inside of container cover (5), in an edge area (10).

6. The container cover (5) of claim 1, in which the groove (9) is in the form of a dovetail groove (9) and/or the gasket (8) is in the form of an elastomer O-ring gasket.

7. The container cover (5) of claim 2, in which part of the land (11) between the grooves is removed (Y), with a preformed part (12) to be inserted into [the space left by] the removed part (Y), and in which the bypass device (18) is arranged on the preformed part (12).

8. The container cover (5) of claim 7, in which the bypass device (18) is arranged on a face of the preformed part (12) and designed as two bypass grooves (20), each extending from a common point on the top of the preformed part (12) down toward the bottom of the preformed part (12) and, if the preformed part (12) is inserted into [the space left by] the removed part (Y), into the grooves (9).

9. The transport and/or storage container, in particular a temporary and/or permanent storage container for contaminated and/or activated substances comprising a container body (1) having a container bottom (3) and at least one container side wall (2), and a container cover (5) of claim 1,
the container body (1) having the filling opening (4) that can be closed by the container cover (5).

10. Transport and/or storage container of claim 9, in which the container cover (5) closes the filling opening (4) in such a way that the land (11) and the container body (1) confine a defined gas volume (14) between them, which is connected with the undefined gas volume (17) through the bypass device (18).

11. Process for testing the leak-tightness of a transport and/or storage container closed with container cover (5) of claim 9, with the step:
a) Evacuation of the gas volume (14, 17).

12. The process of claim 11, with the step:
b) Determination of the leakage rate of the transport and/or storage container.

13. The container cover (5) of claim 2, in which the groove (9) is rectangular and the bypass device (18) is arranged in the area of the bulge facing away from the inside surface of the container cover (5) and/or from the corner of the groove (9) facing away from it.

14. The container cover (5) of claim 13, in which the bypass device (18) is in the form of a bypass groove (20) and/or drill hole between the undefined gas volume (17) and the inside surface of the container cover (5); the bypass device (18) is in the form of a connection groove between the grooves (9); and/or the bypass device (18) is in the form of a bulge in the groove (9) extending from the inside surface of the container cover (5) into the groove (9); and/or the bypass device (18) is in the form of an insert in the groove (9).

15. The container cover (5) of claim 14, in which the grooves (9) run parallel to one another around the periphery of the inside of container cover (5), in an edge area (10).

16. The container cover (5) of claim 15, in which the groove (9) is in the form of a dovetail groove (9) and/or the gasket (8) is in the form of an elastomer O-ring gasket.

17. The container cover (5) of claim 16, in which part of the land (11) between the grooves is removed (Y), with a preformed part (12) to be inserted into [the space left by] the removed part (Y), and in which the bypass device (18) is arranged on the preformed part (12).

18. The container cover (5) of claim 17, in which the bypass device (18) is arranged on a face of the preformed part (12) and designed as two bypass grooves (20), each extending from a common point on the top of the preformed part (12) down toward the bottom of the preformed part (12) and, if the preformed part (12) is inserted into [the space left by] the removed part (Y), into the grooves (9).

19. The transport and/or storage container, in particular a temporary and/or permanent storage container for contaminated and/or activated substances comprising a container body (1) having a container bottom (3) and at least one container side wall (2), and a container cover (5) of claim 18, the container body (1) having the filling opening (4) that can be closed by the container cover (5).

20. Transport and/or storage container of claim 19, in which the container cover (5) closes the filling opening (4) in such a way that the land (11) and the container body (1) confine a defined gas volume (14) between them, which is connected with the undefined gas volume (17) through the bypass device (18).
